(19) United States
(12) Patent Application Publication
(10) Pub. No.: US 2002/0169640 A1
(43) Pub. Date: Nov. 14, 2002

(54) System and method for facilitating asset-based financing in a private sale

(76) Inventor: Bernard G. Freeland, Naples, FL (US)

Correspondence Address: David I. ROCHE, Baker & McKenzie, 130 E. Rondolph Drive, Chicago, IL, 60601, US

(21) Appl. No.: 09/800,621

(22) Filed: Mar. 7, 2001

(51) Int. Cl. G06F 17/60

(52) U.S. Cl. 705/4; 705/37; 705/80

(57) ABSTRACT

A system for facilitating the transfer of titled property from one individual to another individual. In particular, the systems and methods of the present invention enable individual sellers and buyers of such property to engage in and complete transactions with ease without an intermediate title holder, such as a dealer.

The present invention relates to a system for facilitating the transfer of titled property from one individual to another individual. In particular, the systems and methods of the present invention enable individual sellers and buyers of such property engage in and complete transactions with ease without an intermediate title holder such as a dealer.

### BACKGROUND AND SUMMARY OF THE INVENTION

There are approximately fifty-five million vehicles purchased every year. About fifteen and one-half million are new vehicles purchased from new vehicle-franchised dealers. However, forty million are used cars. Of the forty million used cars sold each year, ten million are sold from used vehicle independent dealers, and twelve million are from new vehicle-franchised dealers. Eighteen million vehicles are sold by individuals to other individuals (i.e., “person-to-person”). This person-to-person segment is three and one-half million larger than the number of all new vehicles sold.

Financing and other important services needed in connection with the sale of cars, and other titled personal property, such as boats and recreational vehicles (RVs), have not been available to the general public for person-to-person sales. The present invention enables person-to-person sellers and buyers to have access to integrated financing, escrow services, vehicle inspection services, auto insurance, warranties, vehicle history services, title and registration work, and a neutral meeting place for buyers and sellers in the local market. The combination of these products and services will allow the private seller to provide to the buyer all the services that have in the past only been used in transactions involving a dealer.

Currently, the automobile industry is in transition to consolidate and streamline an inefficient and antiquated new vehicle distribution system. This is being accomplished with the introduction of publicly owned companies and the rapid growth of Internet use thereby providing new and efficient sources of distribution. Many automobile manufacturers have also entered this revolution by buying retail operations and the institution of the one price-selling model. However, all of these models have one major flaw: none effectively deal with the buyer's trade. By eliminating the trade from the purchase process, the system of the present invention will enable the one price model and internet selling model to achieve their full potential. The automobile industry is the largest industry that has to deal with a trade-in, and has therefore been unable to make the transition to non-confrontational and one-price selling models. With the system of the present invention, individuals may buy and sell their vehicles directly, thereby building value for both sides of the transaction. The benefits to the consumer are extensive. The typical dealer makes over $1,800 average gross profit on a used vehicle. A goal of the present invention is to have the buyer and seller (as they may negotiate) share in the benefit that arises from shifting the profit away from dealers. The system of the present invention will put the seller in a position of strength when negotiating to buy his or her next vehicle; he or she will have more equity and will not have to negotiate their trade-in as part of the new (or newer used) car buying process.

At the present time, consumers often find it simply far more convenient to try to trade their vehicle to dealer as part of a new car purchase, instead of trying to sell their cars directly to another individual. The average consumer does not know exactly what they are getting for their trade and dealers are generally reluctant to reveal the exact value of either the used or the new car, preferring to bundle the two transactions, i.e., the trade-in and the new car purchase. The discount given to a new car purchaser for the new vehicle is always applied to the buyers trade to show more for their vehicle than they are actually getting. The present invention provides the consumer with an easy and efficient way to sell their asset at retail to private individuals, and to capture the lost revenue that the dealer would normally receive. Similarly, a large number of people who now buy used vehicles from new and independent car dealers will, by use of the present invention, will be better able to purchase, instead, from private individuals.

Various ways are available to implement the present invention. One particularly suitable is to utilize the Internet as much as possible and to supplement that technology with personnel at local market locations where individuals will meet with agents to list their vehicles and which will provide a neutral meeting site for buyers and sellers. The closings of sales will often be performed at these locations as well as reconditioning, repairs, and accessory sales.

With the advent and widespread use of the Internet, there has arisen a number of listing and information services with web sites relating to the availability of used vehicles. Those web sites include: carsdirect.com, autotrader.com, autodirect.com, etc. The present invention has a particularly advantageous use in connection with such sites. When a seller is listing their vehicle for sale, an experienced agent may, in accordance with the present invention, assist the seller in building a web site for their vehicle that will provide the buyer with information and products to make a confident purchase. This will start with the valuation process, which will utilize industry guidelines to establish wholesale and retail pricing guides. The agent will also perform or arrange for a reconditioning inspection of the item (e.g., a car) to give suggestions for the seller to perform prior to displaying their item. Digital pictures of the item may be taken and loaded on the site as well as scanned maintenance records and attaching a vehicle title history. The seller, perhaps with the help of a system agent, will have the ability to attach industry-related articles, open recalls and reports regarding crash tests which may have been performed on the make and model of the vehicle the seller wishes to sell. Finally, the agent will assist the seller in investigating the financing options available to potential buyers so they can offer their vehicle with financing options, as a dealer would offer it, i.e., with monthly payments calculated, a cash price, and other features and options.

The present invention enables a seller to offer financing to a potential buyer just as a dealer would. This opens up an entire market in this person-to-person segment while attracting a much larger potential group of buyers. Potential buyers will have the ability to arrange a pre-approved loan that can be utilized prior to negotiating with sellers. A financing “portal” will offer all segments of the market financing options, from secondary to high-end specialty financing and leasing.

An important component of the invention is the provision of escrow services as security to the buyer, seller and lender, if one is involved. The security of an escrow ensures that all the funds to transferred as part of the transaction are good, title is clear, proper signatures are obtained, lien(s) have been satisfied, applications for registration are completed, and requirements for warranties have all been accomplished to the parties' mutual satisfaction. In one embodiment, the process will be completely electronic from beginning to end, including vehicle locating, non-financial documentation, funding of the escrow account to facilitate proper funds distribution to related parties, and securing financing for a qualified buyer.

One or more processing centers will electronically handle the majority of the title and vehicle registration processes. This allows proper security to be provided to the lenders and utilizes the security of the escrow service to protect all parties.

Vehicle inspection services are important for a number of reasons. Both buyers and their lenders want the comfort of knowing that a competent mechanic (or other expert, in the case of transactions involving property other than vehicles) has examined the item which is being financed and purchased. Indeed, a seller may also want to induce purchasers by offering their cars with an inspection report. As consumers gain confidence in providers of inspection services in accordance with the present invention, it may be possible for buyers to be comfortable to purchase vehicles without an inspection being performed by them personally, which could lead to transfers conducted purely over the Internet. However, presently, and perhaps for a long time to come, buyers of vehicles generally want to personally inspect a vehicle prior to purchasing it, and will probably appreciate doing so at a neutral location. The system of the present invention provides security and convenience for both buyer and seller, while allowing them to complete recommended repairs and related services.

The present invention maximizes the value of titled asset held by individuals because the services provided in accordance with the invention enable a buyer and a seller to safely complete the transaction. To that end, an escrow service as part of the present invention will allow the seller of a vehicle to transfer ownership of their asset even if there is a payoff. This service is handled quickly and easily by the processing center once all the funds and title has cleared through the escrow department. On a cash transaction, the new title is placed in the consumer's name or if financed a lien is placed after a title search has been done and the funds have cleared. People can successfully transact both buying and selling their assets in a safe and easy fashion.

The use of the present invention allows every customer, regardless of his or her credit rating, to have a better chance of obtaining an financing for a used automobile than their chances are when they go through a traditional dealership. With the system of the present invention, finance sources are able to be more aggressive than traditional lenders because of the additional information received on the asset, such as digital photographs, complete title history, maintenance history, non-biased third party inspections, and seller's disclosure. The present invention utilizes a third party which is fee-compensated, as opposed to the dealer who has purchased and is reselling the vehicle. The sale coordinator is a neutral third party with no monetary gain directly from the sale of the vehicle. Presently and without the system of the present invention, lenders may have to be on guard against dealership personnel who may, in the interest of “pushing the deal,” fail to include information (or in some cases even falsify information) for loan approvals. With the present invention, the lenders will have the comfort of knowing that they are receiving borrower and vehicle information directly from the buyer/borrower.

In the current used vehicle market, the individual seller of a vehicle cannot usually offer any kind of financing to the prospective buyer. The system of the present invention provides a seller with the ability to offer prospective buyers with multi-level, pre-arranged financing. Today, franchise dealers' finance penetration is well above the 80% mark. This means that 80 of 100 used car buyers will require financing. The ability for the seller in a person-to-person transaction to offer financing to the prospective buyer will open an entirely new area to the forty million consumers involved in the used vehicle market. Most used vehicle buyers are also payment buyers. For example, a 1996 Chevrolet Cavalier 4dr base sedan has an N.A.D.A. average retail price of $7200.00 (September 1999 Guide, Florida Edition). If a private seller were to try to sell their vehicle at the retail price ($7200.00) to a prospective buyer, the seller would have a very difficult time convincing a buyer to pay $7200.00 plus tax in cash on a 4 year old model vehicle. However, with financing provided as a result of using the present invention, the seller would be able to offer the buyer a no-money-down purchase option (the buyer may even finance the sales tax) at $199.00 a month for 48 months. Indeed, dealers often attract potential buyers to pay retail when they would not normally do so, because buyers are able and willing to pay $199.00 per month. The present invention relieves the buyer of what is, in effect, a compulsory trade-in of their old car.

The automobile industry is receiving from a variety of sources an unprecedented pressure to change. They range from publicly owned dealer groups such as AutoNation USA, Sonic Automotive, United Auto Group, and Group 1; to Internet based companies such as, CarsDirect.com, CarPoint, Autobytel, AutoWeb, and AutoTrader.com. In addition to these new entries to the automotive scene, some auto manufacturers, such as Ford and General Motors, have purchased a controlling interest in dealer organizations; others, such as Saturn and Mercedes-Benz, have implemented one price selling strategies.

All of these developments are restructuring a distribution system that is inefficient and unpopular in the marketplace. The traditional method of distributing new and used automobiles has built-in expenses, such as excessive facility costs ($390/unit), high inventory costs ($66/unit), sales compensation costs ($392/unit), and advertising expense ($207/unit). These costs do not include the additional marketing and distribution expenses factored into the cost of the vehicles by manufacturers.

The one extenuating circumstance that is hindering the streamlining of automobile industry is the fact that virtually all buyers of new cars own a vehicle that must be sold in order to raise money to be paid toward the new car. This is the reason for the frustration that consumers encounter when they attempt to purchase a vehicle. It is also the reason that manufacturers are unable to set a fixed price on vehicles, because the dealers must still negotiate the value of the trade-in and usually discount their new vehicle by giving the customer more for their car than it is actually worth. This reality is a serious flaw in the current way new cars are marketed.

The present invention effectively deals with the consumer's trade-in vehicle. This is accomplished by providing the products and services necessary to enable buyer and seller to complete the transaction. These services provide large monetary benefits to both buyer and seller by eliminating the traditional dealer or middleman. Once the consumers trade-in is effectively taken care of, the next purchase will be very easy to facilitate by the fact that the consumer has maximized the value of their trade and can effectively purchase in the one price environment.

The present invention not only eliminates many of the problems associated with person-to-person transactions, but it is a sales tax generator because of the fact that individuals will be less likely to misrepresent the actual selling price with a third party involved. State departments of motor vehicles will benefit from the increased use of the system of the present invention.

At least one embodiment of the present invention is system for assisting the transfer of titled property from a selling individual to a buying individual comprising:

an inspection service in which an item to be sold by said selling individual is examined and descriptive information regarding the item is recorded and, optionally, recommended repairs or alterations for the item are suggested;

a title and registration service in which any liens against said property as owned by said selling individual are identified;

an escrow service in which an agent coordinates a transaction in which said property is transferred to the buyer and purchase funds are given to the seller of said property, and any lien-holders holding liens with respect to the selling individual's ownership of said property are satisfied, and any liens to be made by a lender for said buying individual are place on said title.

While the invention is believed to have especially advantageous application in the automobile industry, it also is particularly useful in any transaction involving titled property, such as RVs, trucks, boats and the like.

### BRIEF DESCRIPTION OF THE DRAWINGS

FIG. 1 is an overall diagram showing the basic components of the system of the present invention.

FIG. 2 shows two typical inspection reports as used as part of the present invention.

FIG. 3 is a diagram showing the escrow component of the present invention in a cash transaction.

FIG. 4 is a diagram showing the escrow component of the present invention in a financed transaction.

FIG. 5 is a diagram showing the title and registration component of the system of the present invention.

FIG. 6 is a diagram showing the financing component of the system of the present invention.

### DETAILED DESCRIPTION OF AN EMBODIMENT OF THE INVENTION

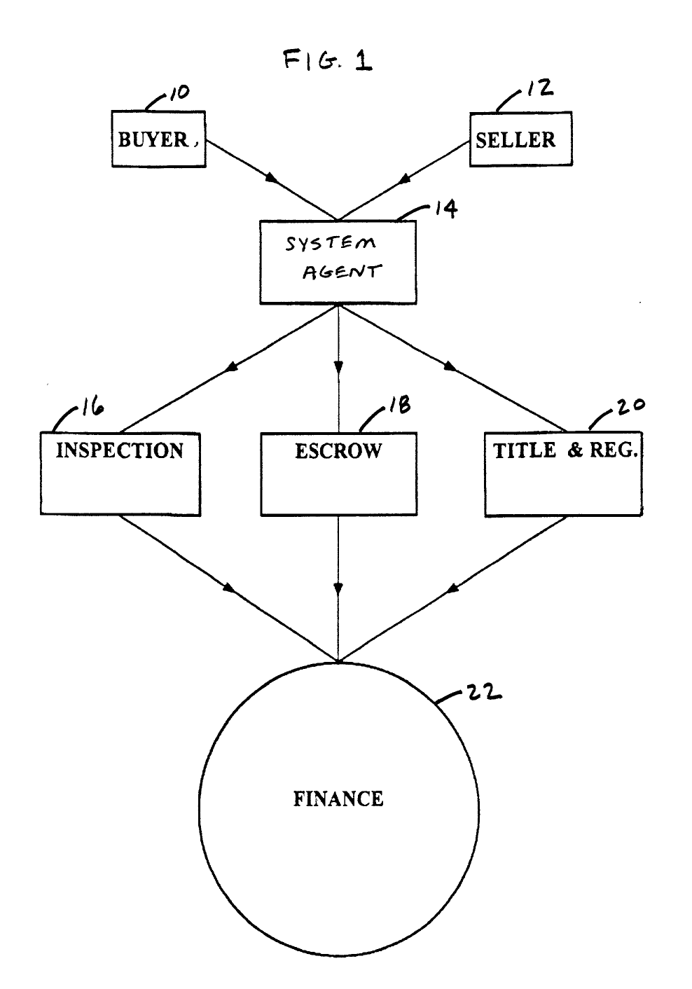

FIG. 1 is an overall diagram of the basic elements of a system embodying the present invention. The system agent 14 in the center of the diagram brings a buyer 10 and a seller 12 together, and without taking title to the property, provides fee-based services to the buyer and seller to facilitate the sale of an item, such as a used car. The system agent may provide inspection services 16, including two kinds of inspections. One is a non-certified body and interior inspection which is part of the basic identification of the item to be offered for sale. This non-certified inspection will most often be performed early in the process as part of the initial offering for sale of a vehicle.

A second, more detailed certified inspection may also be performed, at the expense or request of either the seller or a potential buyer, or at the demand of a lender.

FIG. 1 also shows that the system agent performs an escrow service 18, which may be in connection with a cash transaction or a financed transaction, as discussed in more detail below.

FIG. 1 also indicates that title and registration services 20 will be performed by the system agent (or by a home office with which the agent is affiliated). This service, also explained in more detail below, involves the correct recording of liens, if any, to be made by the buyer's lender, and the application for license plates and vehicle registration.

Body and Interior Inspection (Non-certified)

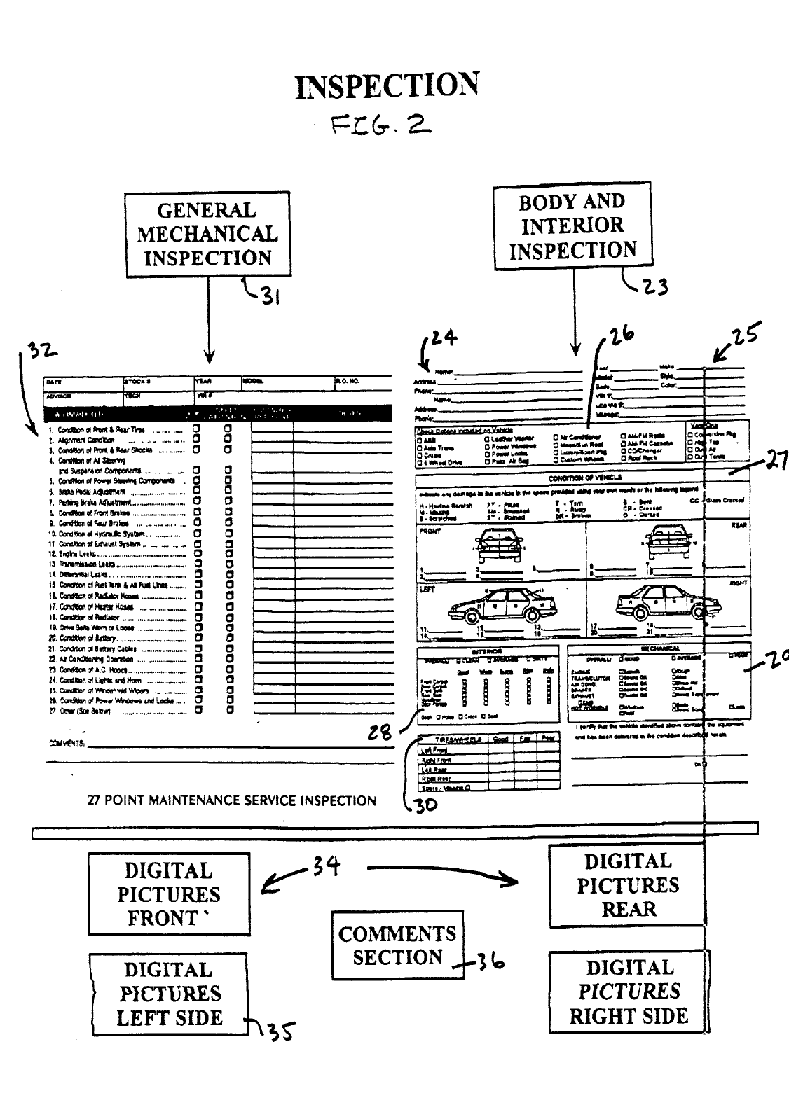

In most instances in which the present invention will be utilized, the system agent will either perform or arrange for a non-certified body and interior inspection 23, as shown in FIG. 2. Such inspection enables buyers to know the general type and condition of the vehicle being offered for sale, i.e., so that the buyer may find the seller's car using various matching systems, such as online matching and classified ad media. It is preferably done by the system agent at a neutral meeting place, such as the system agent's office. This inspection will result in a report (see the right side of FIG. 2) with form sections for the seller's personal information 24, general vehicle information 25, description of vehicle options 26, and evaluations of: 1) the overall condition of the body of the vehicle 27 (and each separate body panel); 2) the interior 28 (e.g., front and rear carpet and seats); 3) mechanical elements 29 (e.g., engine, transmission, air-conditioning, heating, brakes, exhaust, etc.); and 4) tires 30.

The body and interior inspection 23 is not intended to be a representation of the mechanical condition of the vehicle and is not represented as such. The system agent receives all the information from the seller, and the seller signs the initial inspection report. The agent and seller will inspect the outside body of the vehicle, the interior of the vehicle, and highlight any problem areas. These problem areas will be noted in the comment section of the inspection report. All the main factual information about the vehicle, such as mileage, engine type, size, and all equipment options on the vehicle, are also listed on this inspection report. This inspection report's sole purpose is to give the prospective buyer and seller a very general idea of the overall condition of the vehicle. This inspection is also used in conjunction with a more detailed and comprehensive certified mechanical inspection required by lending sources, if the vehicle is to be financed.

Certified Mechanical Inspection

A certified mechanical inspection 31 may be ordered, particularly in financed transactions, and will be done by a certified technician who may be the system agent. Shown in FIG. 2 is a typical 27 point inspection checklist 32, which lists the areas to be inspected. A certified inspection certificate will be issued and signed by the technician based on the multi-point inspection. If the technician finds a problem or potential problem, the technician will make a note on the inspection certificate, see the right side of checklist 32. The exact problem is noted in the comment section of the certificate along with the estimate of the cost of repairs may be made, if requested. This inspection certificate is especially important if the vehicle is to be financed, because lenders will need to know the quality of the collateral for the loan they will be making.

The inspection is by a third party, who is neutral in that the cost of the inspection may be borne by either the buyer or the seller or shared by them, and neither of which is known by the inspecting technician. The inspection certificate, along with a complete description of the vehicle, will allow the lending institution to decide on the value that is to be placed on the vehicle. The buyer or the seller can purchase the inspection certificate. Because the technician is neutral in the inspection process, the funding source will have a very clear and accurate understanding of the condition of the asset.

A certified general mechanical inspection will likely include an examination of at least the following:

| | |
|---|---|
| Condition of Front and Rear Tire | Condition of Fuel Tank and All |
| | Fuel Lines |
| Alignment Condition | Condition of Radiator Hoses |
| Condition of Front and Rear Shocks | Condition of Heater Hoses |
| Condition of All Steering and | Condition of Radiator |
| Suspension | |
| Components | Driving Belts Worn or Loose |
| Condition of Power Steering | Condition of Battery |
| Components | |
| Brake Pedal Adjustment | Condition of Battery Cables |
| Parking Brake Adjustment | Air Conditioning Operation |
| Condition of Front Brakes | Condition of A.C. Hoses |
| Condition of Rear Brakes | Condition of Lights and Horn |
| Condition of Hydraulic System | Condition of Windshield Wipers |
| Condition of Exhaust System | Condition of Power Windows and |
| | Locks |
| Engine Leaks | Other (Specify) |
| Transmission Leaks | _{——————————} |
| Differential Leaks | _{——————————} |

When a vehicle is brought into a system agent's location, the seller or buyer can purchase a vehicle inspection, which may be performed by the agent or by a certified sub-contractor, e.g., a local certified mechanic. The inspection form is given to a certified mechanic to complete. Forms may be pre-printed or printable from a website available to the agent or his subcontractor. The mechanic then returns the completed inspection to the system agent and the system agent enters the inspection results into the system. Alternatively the agent may scan the report to create electronic version of the inspection report. Preferably, once inspection has been completed, either the seller, buyer, or a member of the agent's staff can view or print the vehicle inspection report at any time. The form, shown in FIG. 2, may also provide space 34 for digital photos 35 and a comment section 36 where special attributes of the vehicle may be noted and called to the attention of potential buyers.

Escrow Service

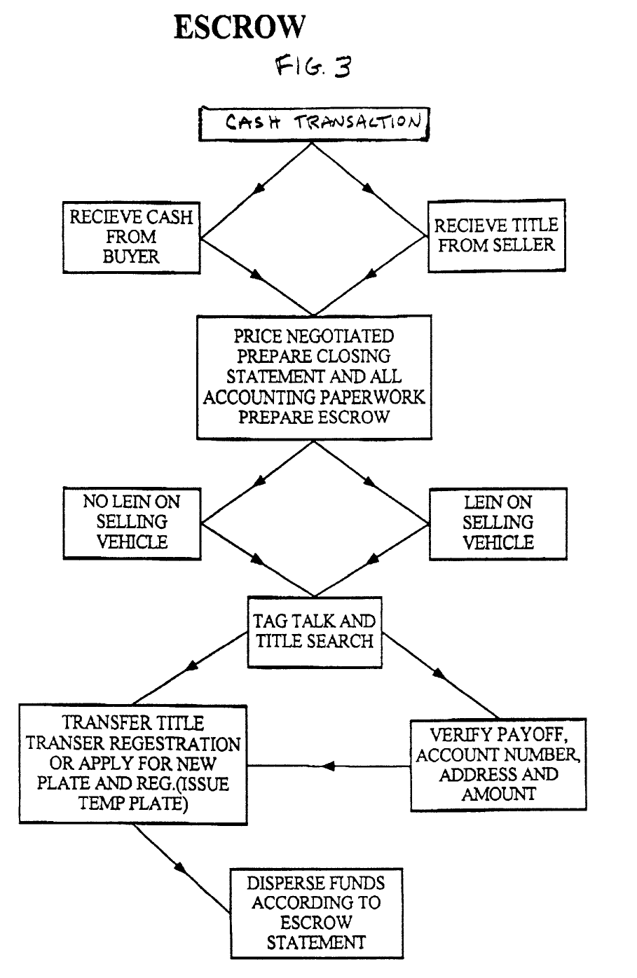

The escrow portion of the present invention for a cash transaction is shown diagrammatically in FIG. 3. In a cash transaction, the escrow agent receives cash, check or certified funds from the buyer. The escrow agent receives the title from the seller. All negotiations are completed as they relate to the sale price of the vehicle and a closing statement is prepared. The buyer's fees and related information, such as expenses shared by the buyer, are detailed on the closing statement, as are the seller's fees and expenses. The calculations on the closing statement are reviewed and, if accept, the statement is signed by both the buyer and seller. All the documentation is held in escrow until the funds are cleared and a title search has been done and checked for accuracy to determine that there are no unexpected liens against the asset being transferred. If there is a lien on the vehicle, the escrow agent will check the title search document for matching information, verify the account number and address of the lien holder, and pay the discharge the lien from the cleared funds of the buyer. After this has been accomplished, the accounting documentation is prepared and the closing appointment is set. At the closing, the buyer receives the registration and vehicle tag from the escrow agent (or the receipt therefor) and the seller receives the cleared funds from the buyer as set forth in the closing statement.

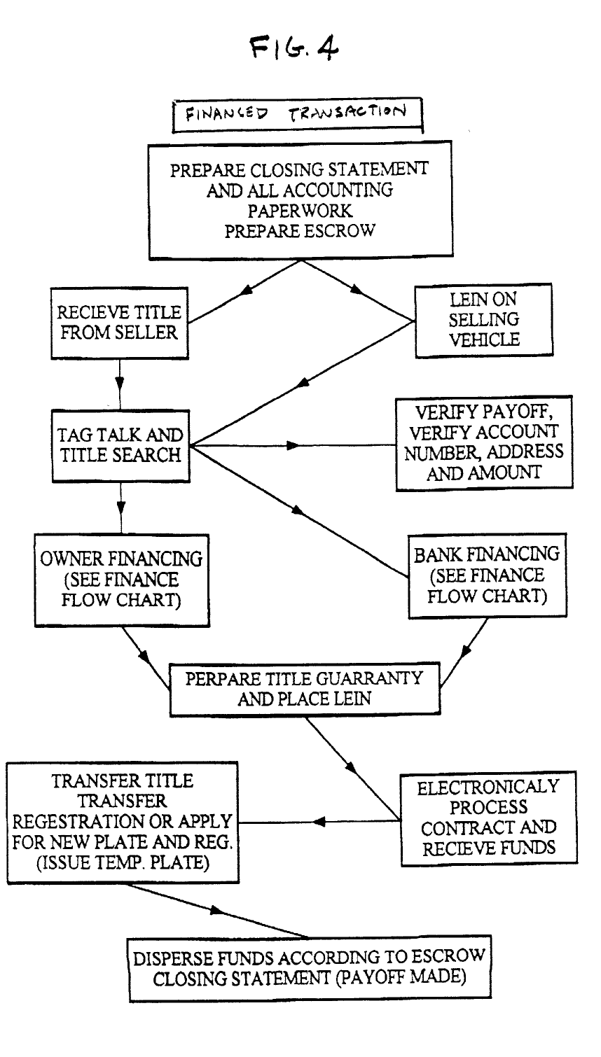

The escrow portion of the present invention for a financed transaction is shown diagrammatically in FIG. 4. In a transaction where financing will be needed by the buyer, all the processes as stated above with respect to a cash transaction will be instituted with the exception that the funds to pay the seller will be coming from a finance source, instead of the buyer. The proceeds of the sale will be dispersed in accordance with the closing statement as soon as all related finance documents have been completed and funds have cleared from the finance source.

Title and Registration

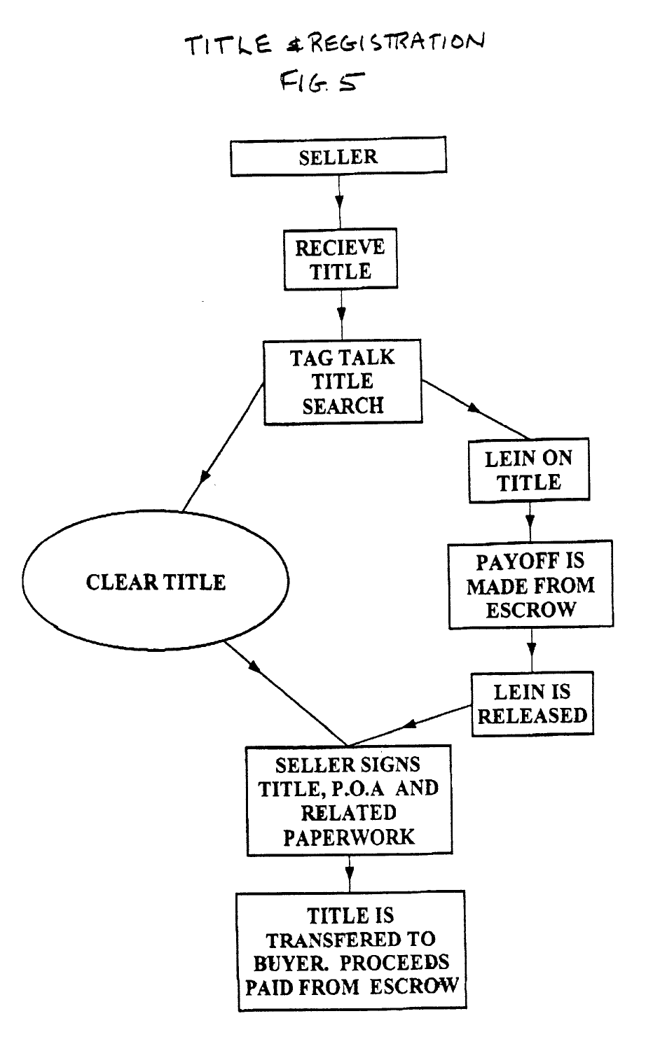

FIG. 5 shows the title and registration sub-part of the present invention. This part of the present invention assumes that the transaction takes place in a state where the seller does not have physical possession of the title if there is a lien. If the vehicle does not have a lien, the seller would have the actual title. The seller would bring the title to the vehicle and hand it over to the system agent. The system agent would then apply for a title search to verify that there are no other outstanding and valid liens on the vehicle. When the information from the title search is received by the system agent, and if the title is shown in the search to be clear, then the title is ready to be transferred to the buyer. The seller signs and supplies all the necessary information on the face of the title and signs a motor vehicle power of attorney (POA), and any other documents required (e.g. by the buyer's lender) to complete the transaction. The title will thereafter be transferred to the buyer either electronically or through a manual process. Once the title has been properly transferred to the buyer, the funds may be released from the escrow according to the closing statement.

If there is a lien on the vehicle and the lien-holder possesses the title, a verified payoff will be made from the escrow according to the closing statement in exchange for the title being given to the system agent by the lien-holder. In the case of a lien payoff, the system agent will schedule a meeting with the seller to complete and sign the title (as described above) after the title is received from the lien-holder. When all documentation is complete an escrow deal jacket is prepared and sent to a processing center for completion. Once processing of the transaction is complete (i.e. a new title issued and loan proceeds approved for release) a closing is held at which funds are released to the seller and the title is given to the buyer along with the purchased vehicle.

Finance Flow Chart

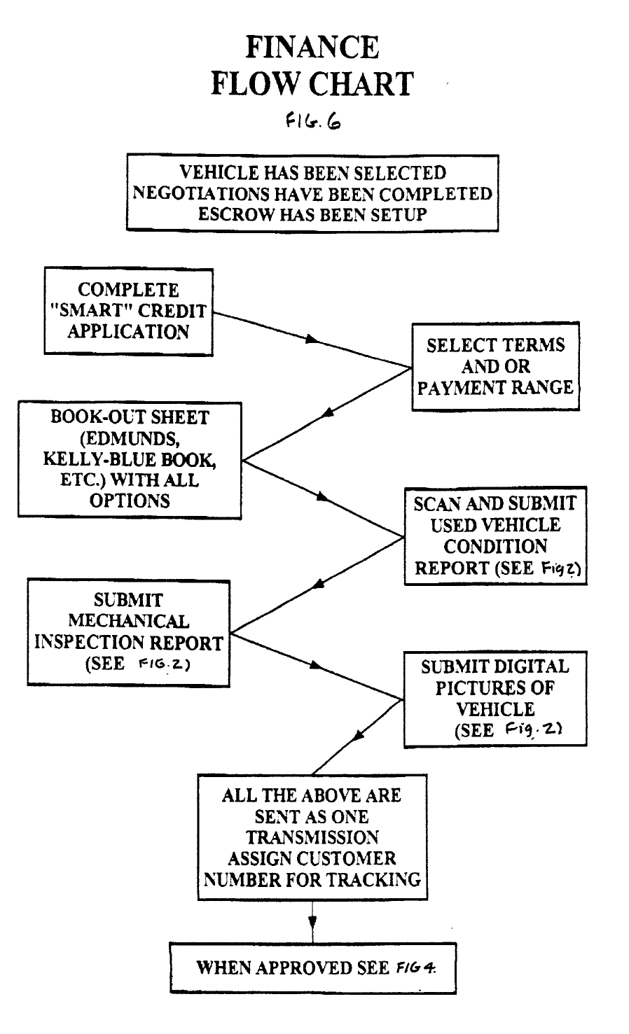

FIG. 6 is a flow chart of the steps required to arrange for financing of a titled property, such as a vehicle, in accordance with the present invention. Once a buyer and seller have negotiated a price, an escrow is established for the transaction. The buyer completes a credit application, which may be done online, i.e., a “smart” application, which forces an applicant to provide all essential information before it may be transmitted. The buyer decides on the terms of his loan, e.g. 36 months vs. 48 months. A book-out sheet is prepared showing a value of the vehicle. The next step is to obtain the non-certified body and interior inspection report 23. Then, the certified mechanical inspection report is prepared. Pictures of the vehicle are obtained, preferably digitally so that the application may be transferred and handled entirely electronically. All of the foregoing, i.e., the loan application, the terms, the blue book information, the inspection reports and the pictures, are all assigned a tracking number and are sent to one or more lenders for approval. Once approval for the loan is obtained the process of FIG. 4 may begin.

A new customer who wishes to list a vehicle for sale and utilize the system of the present invention will ordinarily be required to create a customer profile. The template, which may be an online form accessible via the Internet, should include basic customer contact information. A customer, in this case a seller, can expose the profile to potential purchasers and specify a preferred method of contact (i.e., web, e-mail, phone, etc.). Whether a customer is creating a vehicle listing from the comforts of home or at an agent location, the vehicle template provides is preferably common for all vehicle listings in the system.

Each vehicle listing will include the following:

Body and Interior Inspection Report (Non-certified)

General Mechanical Inspection (Certified)

Industry Articles (if any)

Title History

Blue Book Values

Primary vehicle listing where commonly used vehicle information is presented, along with space for a photo of the vehicle and vehicle identification number (VIN). In addition to at least the non-certified inspection report data (and optionally the certified general mechanical inspection report), a customer can also add a personal description of the vehicle along with additional comments.

Industry articles for a specific vehicle will be included as part of the vehicle listing report. If a title history has been ordered for the vehicle, its results would be displayed in this section. Title history order business process will be defined in the function design phase. Kelly Blue Book or other used vehicle valuation services will be available for the listed vehicle. Here, sellers or buyers can order a vehicle's title history. This information will be provided by a service like CarFax (http://www.carfax.com). Results may be readily displayed on a computer available to the system agent.

When a seller agrees to transfer a vehicle to a prospective buyer, the two parties begin negotiation, and eventually agree on purchase price and repairs to be made. Both buyer and seller will sign a closing agreement. Throughout the sales process, it may be helpful for the parties to be kept current. If the system is implemented using a website, a standard, read-only status report may be used. It may, for example, display the seller's requirements and target date of completion of the sale. It may also inform the seller about documentation which needs to be submitted before the process can continue. This status report and will be controlled and edited by the system agent. The results of the account management process are available for review by the buyer. Securing the confidentiality of all sensitive or personal information may be achieved with commonly available password protection software.

Potential used auto buyers will access the inventory and decide to purchase services for a specific listed vehicle. Buyers may opt to buy fee-based services throughout the used vehicle purchasing process or before deciding on a specific vehicle. The components of this system may include:

Vehicle Searching

Financing

Title Searching

Warranty

After-Market Products

Account Status Report

The initial Internet screen features an advanced vehicle search form capable of pulling from a variety of inventories (i.e., Auto Trader, Cars.com). Customers will select from several filters to return to a list of vehicles that meets their criteria. Return results may provide hypertext links to vehicle detail reports. Buyers can also request notification for when a wanted vehicle is posted to the inventory.

Potential buyers may be presented with two options to choose from: pre-approved financing and traditional financing. Each process will require information to be sent to a financing vendor, such as a bank or an online service such as giggocar.com. The required information will depend upon the particular requirements of each financing source, and will often be available in electronic format so that the borrower can deal easily and directly with the lender.

The system agent may enter into an agreement with an auto warranty service provider (e.g., Warranty Gold) to sell used car warranties to buyers. The program will have to send data to the warranty vendor either in the form of e-mail, regular mail or other means of communication. While the data transfer method is unknown, until an agreement is met with a vendor, software available to the system agent will, at minimum, provide a form with key fields to be submitted to a vendor. Transferring required information will be determined at a later date.

As an adjunct to the present invention, the system agent may be able to cross-sell after-market auto parts and supplies for a variety of used vehicles. A buyer may purchase after-market products and drop them into their shopping cart. The customer can select items for his newly acquired used vehicle and purchase said items from an internet site created by the system agent, his or her home office, or directly from a store at the system agent's location.

Each party in the vehicle sales transaction needs a status report of all aspects of the sale. A standard read-only status report will display the buyer's requirements and the date of completion. It will also inform the buyer about documentation which needs to be submitted before the process can continue. This is a status report and will be controlled and edited by the system agent or his or her home office. The results of the account management process are available for review by the buyer.

A central processor may be used to facilitate the system agent's operations and for management processes relating to the customer deal. This role includes the very important escrow account management of system agent's service. Each processor, located at home office, may control the workflow for each buyer and seller deal. The central processor, instead of the system agent, may take responsibility for verifying funds, avoiding vendor obstacles and making payoffs.

The operations of the central processor may also be designed to communicate with an off-the-shelf accounting software packages. This may help avoid possible communication and information conflicts that may exist using a manual process for reconciling transactions.

The system agent needs to know the status of the buyer, seller and vendors (i.e., lender, tag and title, etc.) transactions. The system agent will indicate when documents have been submitted, when funds are verified, when funds are dispensed, and communicate what is also needed from any party involved with the transaction.

The system agent controls the success and speed of the transaction. All aspects of account management will be available to the system agent, and the agent may establish deadlines for various steps in the process.

Off-site operations of the central processor may be accessible by several of the system agents. Those off-site or remote operations may assist the buyer, the seller or the agent during purchasing process, for example to produce required purchasing documents, capture legal documents (i.e., scanned title), and status reports. The system agent will preferably have the ability to scan certain documents (such as title) and make them available on-line.

When a customer visits a system agent, the agent may need to retrieve a customer's initial documentation. If that information is stored online using the internet, access may require the use of variety of filters, including but not limited, to social security number, name, listed vehicle(s), VIN or zip code.

A communication interface with each subscribed vendor will require the development of one or more forms. These forms may include sending data to the vendor over the Internet. Communication may also require printable documents sent to a fax machine or through a shipping provider (e.g., UPS).

Reports will provide a mechanism for a home office or agent control center to monitor the transactions of various agents at different locations. The agent control center may also assist agents with managing customers and with escrow account management.

Employees can store custom reports for later use by all employees at the same job level. For example, if a manager builds a custom report, he can save the report's configuration for later use, making it available to all managers with his access rights. An Agent can save a custom report that will be available for all users with the same security rights.

Workflow reports (automated and manual) may include printable reports used to facilitate the daily operation of multiple agents. Such reports may sent to outside vendors, state agencies, internal employees, and customers. For example, a potential buyer orders a vehicle inspection. The system agent prints an inspection report from the vehicle-listing screen, then hands the report to the mechanic.

| REPORT NAME | DESCRIPTION |
|---|---|
| Vehicle Inspection | Checklist given to certified mechanic. Report is returned to |
| | agent where results are input into the system. |
| Title Report | Printable version of vehicle's Title search results. This may |
| | include liens on the vehicle. |
| Escrow Reports | Report shows functions relating to the funding process. |
| | Report's audience includes customer, agent, processor and |
| | lender. Presented as a status report of the escrow transaction. |
| Escrow Account | Used by a system agent to cross-reference account information |
| | from bank statement. Should identify possible related |
| | information against current vehicle transactions. |
| Insurance Verification | Digitally signed by the buyer legally confirming insurance |
| | obligations. |
| Closing Statement | All aspects of the vehicle transaction, agreed upon by both |
| | buyer and seller, is represented on the Closing Statement |
| | report and must be signed (digitally or manually) by both parties. |

Additionally, a home office associated with the system agent may want to track all fee-based services, such as:

vehicle listing

vehicle inspection

title history

licensee/registration

financing

after-market products

A variety of financing options may be presented to potential buyers. The system agent initiates the sales process with a buyer and obtains the lending details required by the lender. Data is then sent to a lending institution (e.g., giggocar.com, a local bank etc.), where the lender has a lending approval criteria. The lender will contact the customer and obtain additional information, including but not limited to, a credit application, pay stubs, employment history, etc. The system agent does not manage the loan process. However, the system agent, e.g., by making follow-up calls or emails, does monitor the status of a buyer's financing to reduce the aging of a deal.

Although only preferred embodiments of the present invention have been illustrated and described above, it will be apparent to those skilled in the art that variations may be made which are different from the discussed embodiments without departing from the spirit and the scope of the invention.

What is claimed is:

1. A method for facilitating asset-based financing in a private sale of a titled asset comprising:
validating a titled asset to be sold by a seller to a buyer,
arranging for financing by a lender of funds to be paid to a seller for said asset on behalf of a buyer,
providing an escrow service for ensuring that financial and legal aspects of said sale occur in an orderly manner,
all of said steps taking place without an intermediate transfer of ownership of said asset from said seller to any party other than said buyer.

2. A method in accordance with claim 1 wherein said validation comprises an examination of the asset and creation of descriptive information regarding the asset and its condition, and recording said descriptive information in a report.

3. A method in accordance with claim 2 wherein said validation comprises an inspection of the asset and a recommendation for repairs or alterations of the asset.

4. A method in accordance with claim 1 wherein said method includes additional steps selected from the group consisting of: providing tag and title services in which requirements for licensing and registration of the asset with governmental officials are fulfilled, resolving liens held by previous lenders of money to said seller by paying all monies owed lienholders existing at the time of sale, and attending to recordal of new liens associated with borrowing by said buyer.

5. A method in accordance with claim 1 wherein said method includes providing tag and title services in which requirements for licensing and registration of the asset with governmental officials are fulfilled.

6. A method in accordance with claim 1 wherein said method includes resolving liens held by previous lenders of money to said seller by paying all monies owed lienholders existing at the time of sale.

7. A method in accordance with claim 1 wherein said method includes attending to recordal of new liens associated with borrowing by said buyer.

8. A method for facilitating asset-based financing in a private sale of a titled vehicle comprising:
validating a titled vehicle to be sold by a seller to a buyer, said validating including an inspection of said vehicle to confirm its make, model and condition,
arranging for financing by a lender of funds to be paid to a seller for said vehicle on behalf of a buyer,
providing an escrow service in which an agent coordinates said sale, and makes arrangements for said vehicle and title to said vehicle to be transferred to the buyer, arranges for purchase funds to be given to the seller of said vehicle, and attends to satisfaction of any liens with respect to the seller's ownership of said vehicle, and attends to recordal of any liens to be made by a lender of funds to said buyer on said title,
all of said steps taking place without an intermediate transfer of ownership of said vehicle from said seller to any party other than said buyer.

9. A method in accordance with claim 8 wherein said validating comprises preparation of a descriptive information report with recommendations for maintenance, repair and/or alteration of said vehicle.

10. A system for facilitating asset-based financing in a person-to-person sale of a titled asset comprising:
a validating service in which a titled asset to be sold by a seller to a buyer is inspected and characteristics of said asset are certified,
a finance arrangement service in which a potential lender is provided information about said asset, and funds to be paid to a seller for said asset on behalf of a buyer are made available by said lender to said buyer based upon documentation containing information regarding said buyer.
an escrow service for ensuring that financial and legal aspects of said sale occur in an orderly manner,
all of said services being provided so as to allow said sale to take place without an intermediate transfer of ownership of said vehicle from said seller to any party other than said buyer.

11. A system in accordance with claim 10 wherein said validation service comprises an examination of the asset by a technician familiar with assets of the type to be sold, and said technician creates a written report containing descriptive information regarding the asset and its condition.

12. A system in accordance with claim 11 wherein said asset is a vehicle and validation comprises an inspection of the vehicle and a recommendation for repairs or alterations of the vehicle.

13. A system in accordance with claim 10 wherein said system includes additional services selected from the group consisting of: tag and title services in which requirements for licensing and registration of the asset with governmental officials are fulfilled, resolution of liens held by previous lenders of money to said seller by paying all monies owed lienholders existing at the time of sale, and recordal of new liens associated with borrowing by said buyer.

14. A system in accordance with claim 10 wherein said system includes tag and title services in which requirements for licensing and registration of the asset with governmental officials are fulfilled.

15. A system in accordance with claim 10 wherein said system includes a service for resolving liens held by previous lenders of money to said seller by paying all monies owed lienholders existing at the time of sale.

16. A system in accordance with claim 10 wherein said system includes attending to recordal of new liens associated with borrowing by said buyer.
